(19) United States
(12) Patent Application Publication
(10) Pub. No.: US 2024/0307247 A1
(43) Pub. Date: Sep. 19, 2024

(54) MOTION ASSIST APPARATUS COMPRISING MOUNT WITH FRICTION REDUCING MEMBER

(71) Applicant: SAMSUNG ELECTRONICS CO., LTD., Suwon-si (KR)

(72) Inventor: Kuemjong BAE, Suwon-si (KR)

(21) Appl. No.: 18/672,556

(22) Filed: May 23, 2024

Related U.S. Application Data
(63) Continuation of application No. PCT/KR2023/006183, filed on May 8, 2023.

(30) Foreign Application Priority Data
May 12, 2022 (KR) 10-2022-0058540
Sep. 5, 2022 (KR) 10-2022-0112086

(51) Int. Cl. A61H 1/02; A61H 3/00

(52) U.S. Cl. CPC A61H 1/0262; A61H 1/0266; A61H 1/0277; A61H 1/0281; A61H 3/00; A61H 2003/007; A61H 2201/1207; A61H 2201/14; A61H 2201/1463

(57) ABSTRACT

A motion assist apparatus may include a mount with a friction reducing member may include a proximal support configured to support a proximal part of a user, a distal support configured to support a distal part of the user, an actuator connected to the proximal support and configured to generate power, a driving frame configured to transmit power from the actuator to the distal support, a slider housing connected to the distal support, a slider including a slider body slidably provided in the slider housing, a slider head protruding from the slider body, and a head hole formed through the slider head, a mount connected to the driving frame and configured to accommodate the slider head therein, a shaft passing through the head hole and fixed to the slider head, and a friction reducing member configured to support the shaft and accommodated in the mount.

### CROSS-REFERENCE TO RELATED APPLICATIONS

This application is a continuation application of International Application No. PCT/KR2023/006183 designating the United States, filed on May 8, 2023, in the Korean Intellectual Property Receiving Office and claiming priority to Korean Patent Application No. 10-2022-0058540, filed on May 12, 2022, and to Korean Patent Application No. 10-2022-0112086, filed on Sep. 5, 2022, in the Korean Intellectual Property Office, the disclosures of which are incorporated by reference herein in their entireties.

### BACKGROUND

### Technical Field

Various example embodiments relate to a motion assist apparatus including a mount in which a friction reducing member may be accommodated.

### Description of Related Art

In a rapidly aging society, a growing number of people have experienced inconvenience and pain from joint problems and interest in an assist device for assisting elderly users and patients in walking with ease has increased. A motion assist apparatus may also be worn to increase muscular strength of a certain body part.

### SUMMARY

According to an example embodiment, a motion assist apparatus including a mount with a friction reducing member may include a proximal support configured to support a proximal part of a user, a distal support configured to support a distal part of the user, an actuator connected to, directly or indirectly, the proximal support and configured to generate power, a driving frame configured to transmit power from the actuator to the distal support, a slider housing connected, directly or indirectly, to the distal support and having a sliding space, a slider including a slider body slidably provided in the sliding space, a slider head protruding from the slider body, and a head hole formed through the slider head, a mount connected, directly or indirectly, to the driving frame and configured to accommodate the slider head therein, a shaft passing through the head hole and fixed to the slider head, and a friction reducing member configured to support the shaft and accommodated in the mount.

### BRIEF DESCRIPTION OF DRAWINGS

The above and other aspects, features, and advantages of certain example embodiments of the present disclosure will be more apparent from the following detailed description, taken in conjunction with the accompanying drawings, in which:

FIG. 1 is a perspective view illustrating a user wearing a motion assist apparatus according to an example embodiment.

FIG. 2 is a perspective view illustrating a driving frame, a mount, a slider, and a slider housing according to an example embodiment.

FIG. 3 is an exploded perspective view illustrating the driving frame, an upper mount, a lower mount, a friction reducing member, a shaft, the slider, and the slider housing according to an example embodiment.

FIG. 4 is a cross-sectional view taken along a line IV-IV of FIG. 2.

FIG. 5 is a perspective view illustrating the lower mount according to an example embodiment.

FIG. 6 is a perspective view illustrating the upper mount according to an example embodiment.

FIG. 7 is a side view illustrating the friction reducing member supported by an upper holder and a lower groove according to an example embodiment.

FIG. 8 is a side view illustrating the shaft supported by a slider head according to an example embodiment.

FIG. 9 is a perspective view schematically illustrating a user wearing a motion assist apparatus on the upper arm of the user according to an example embodiment.

### DETAILED DESCRIPTION

The following detailed structural or functional description is provided as an example only and various alterations and modifications may be made to examples. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the embodiments described above and an element having a common function. Unless otherwise mentioned, the descriptions of the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like elements and any repeated description related thereto will be omitted.

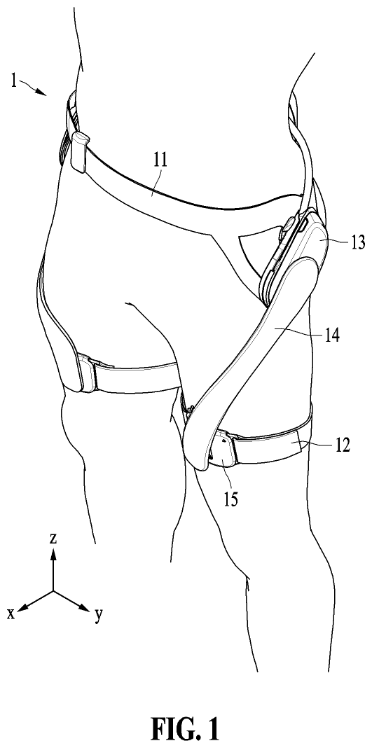

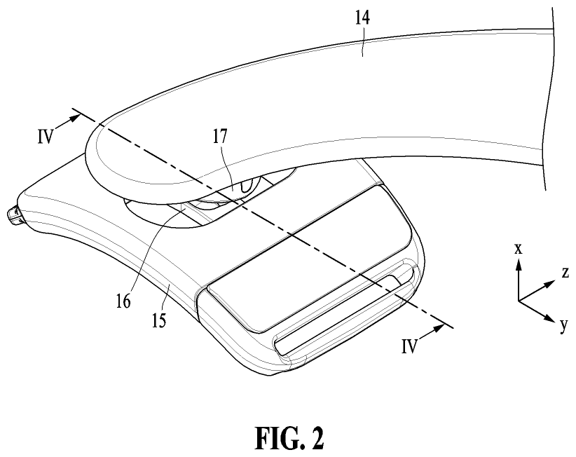

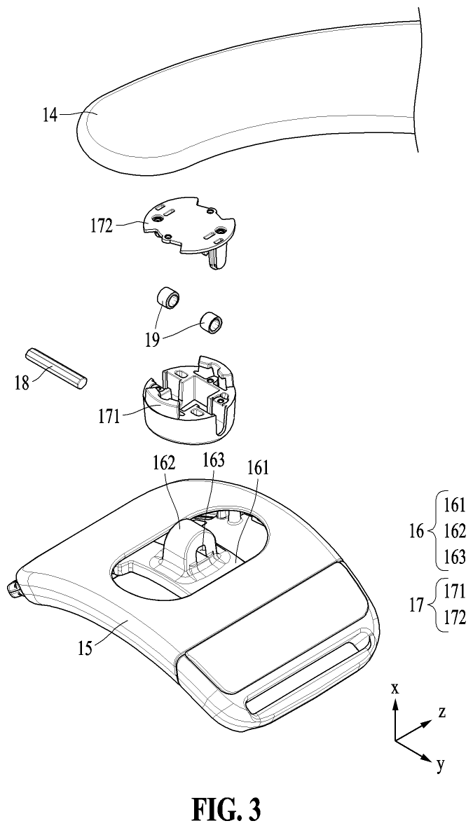

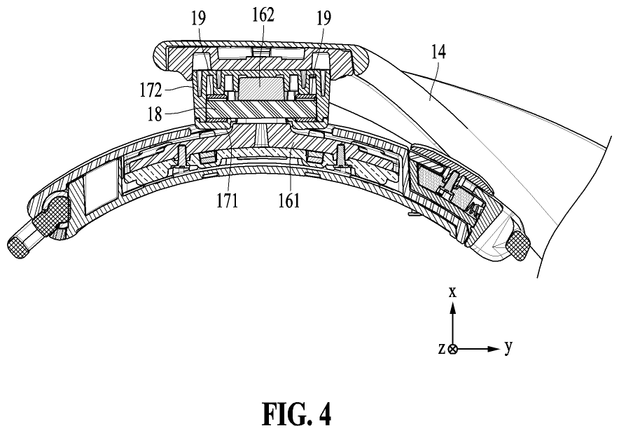

FIG. 1 is a perspective view illustrating a user wearing a motion assist apparatus according to an embodiment. FIG. 2 is a perspective view illustrating a driving frame, a mount, a slider, and a slider housing according to an embodiment. FIG. 3 is an exploded perspective view illustrating the driving frame, an upper mount, a lower mount, a friction reducing member, a shaft, the slider, and the slider housing according to an embodiment. FIG. 4 is a cross-sectional view taken along a line IV-IV of FIG. 2.

Referring to FIGS. 1 to 4, according to an embodiment, a motion assist apparatus 1 may be worn by a user and assist the motion of the user. The user may be a human, an animal, or a robot, but examples are not limited thereto. The motion assist apparatus 1 may assist the motion of some joints of the upper or lower body of the user. For example, the motion assist apparatus 1 may assist the motion of the lower body of the user by assisting at least one of the hip joint, the knee joint, and the ankle joint of the user. For example, the motion assist apparatus 1 may assist the motion of the upper body of the user by assisting at least one of the shoulder joint, the elbow joint, and the wrist joint of the user. The motion assist apparatus 1 may assist the user in walking by assisting the motion of some lower body joints of the user. Hereinafter, the description is provided on the motion assist apparatus 1 assisting the user in walking by assisting the motion of the hip joint of the user, but a wearing part and a target joint of the motion assist apparatus 1 are not limited thereto. The motion assist apparatus 1 may include a proximal support 11, a distal support 12, an actuator 13, a driving frame 14, a slider housing 15, a slider 16, and a mount 17.

In an embodiment, the proximal support 11 and the distal support 12 may be opposite to each other based on one body part of the user and respectively support a proximal part and a distal part. For example, the proximal support 11 may support the waist and/or the pelvis of the user and the distal support 12 may support the thigh, the knee, the calf, and/or the foot of the user. The proximal support 11 may include a detachable belt for supporting the waist of the user all around. The distal support 12 may include a detachable belt for supporting the thigh of the user all around.

In another example, the proximal support 11 and the distal support 12 may be opposite to each other based on the upper arm of the user, and the proximal support 11 may support, for example, the shoulder and/or the back of the user and the distal support 12 may support, for example, the forearm of the user. For example, the proximal support 11 may include a detachable belt for supporting the shoulder of the user all around and the distal support 12 may include a detachable belt for supporting the forearm of the user all around or a structure surrounding the forearm of the user all around.

In an embodiment, the proximal support 11 and the distal support 12 may move relative to each other on a sagittal plane. For example, when the user wearing the motion assist apparatus 1 flexes or extends the hip joint of the user, the distal support 12 may rotate relative to the proximal support 11 on the sagittal plane.

In an embodiment, the proximal support 11 and the distal support 12 may move relative to each other on a frontal plane. For example, when the user wearing the motion assist apparatus 1 adducts or abducts the hip joint of the user, the distal support 12 may rotate relative to the proximal support 11 on the frontal plane.

In an embodiment, the driving frame 14 and the distal support 12 may move relative to each other on a transverse plane. For example, when the user wearing the motion assist apparatus 1 rotates the thigh of the user, the distal support 12 may rotate with the thigh of the user in close contact with the thigh of the user. That is, the distal support 12 may rotate relative to the driving frame 14. According to this structure, the wearability of the user may increase.

In an embodiment, the actuator 13 may be connected, directly or indirectly, to the proximal support 11 and generate power. The actuator 13 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an embodiment, the driving frame 14 may transmit power generated by the actuator 13 to the distal support 12. For example, the driving frame 14 may assist the motion of the hip joint of the user. When an output terminal of the actuator 13 rotates in one direction, the driving frame 14 may receive power from the actuator 13 and assist the flexion motion of the hip joint of the user. When the output terminal of the actuator 13 rotates in the opposite direction to the one direction, the driving frame 14 may receive power from the actuator 13 and assist the extension motion of the hip joint of the user. The description is provided that the driving frame 14 assists the motion of the hip joint of the user, but a function of the driving frame 14 is not limited thereto. For example, when the motion assist apparatus 1 is used to assist the motion of joints of the upper body of the user, the driving frame 14 may assist the motion of the shoulder or elbow joint of the user.

In an embodiment, the slider housing 15 may be connected, directly or indirectly, to the distal support 12 and may face the driving frame 14. For example, the slider housing 15 may have a shape surrounding the distal part of the user. When the user wearing the motion assist apparatus 1 flexes or extends the hip joint of the user, the slider housing 15 may rotate relative to the driving frame 14 on the sagittal plane. The slider housing 15 may have a sliding space in which the slider 16 may move. For example, the sliding space may be formed in the y-axis direction or the z-axis direction.

In an embodiment, the slider 16 may be slidably provided in the slider housing 15. For example, the slider 16 may move along a rail provided in the slider housing 15. For example, the slider 16 may be moved by elasticity of a spring provided in the slider housing 15. The slider 16 may move along the sliding space. For example, the slider 16 may move in the y-axis direction or the z-axis direction with respect to the slider housing 15. The distal support 12 may move relative to the driving frame 14. The slider 16 may include a slider body 161, a slider head 162, and a head hole 163.

In an embodiment, the slider body 161 may be slidably provided in the sliding space. The slider head 162 may protrude from the slider body 161. For example, the slider head 162 may be formed at the center of the slider body 161. The slider head 162 may be accommodated in the mount 17. For example, the slider head 162 may have a convex shape in a direction away from the slider body 161. The head hole 163 may be formed through the slider head 162.

In an embodiment, the mount 17 may connect the driving frame 14 to the slider 16. The mount 17 may be disposed between the driving frame 14 and the slider 16. The slider 16 may not be directly connected to the driving frame 14. The magnitude of torsion, rotation, or shearing force transmitted from the driving frame 14 to the slider 16 may decrease.

In an embodiment, a shaft 18 and a friction reducing member 19 may be provided in the mount 17. The mount 17 may include a lower mount 171 and an upper mount 172. The lower mount 171 and the upper mount 172 may be provided on opposite sides based on the shaft 18 and may be coupled, directly or indirectly, to each other.

In an embodiment, the shaft 18 may pass through the head hole 163 and be fixed to the slider head 162. The slider 16 may not rotate with respect to the shaft 18. The slider 16 may rotate integrally with the shaft 18. The slider housing 15 may rotate with respect to the mount 17. The distal support 12 may rotate with respect to the proximal support 11.

In an embodiment, the friction reducing member 19 which may be supported by, directly or indirectly, the lower mount 171 and the upper mount 172. The friction reducing member 19 may be fixed inside the mount 17. The friction reducing member 19 (e.g., a support) may support the shaft 18. For example, the friction reducing member 19 may be a bush into which the shaft 18 may be inserted. When the shaft 18 rotates in a state supported by, directly or indirectly, the friction reducing member 19, noise or squeaks may decrease. The dust resulting from the rotation of the shaft 18 may decrease. The wearability of the motion assist apparatus 1 may increase.

In an embodiment, the friction reducing member 19 may be provided in plurality. For example, the friction reducing members 19 may be provided as a pair. The slider head 162 may be provided between the pair of friction reducing members 19.

In the drawings, the friction reducing member 19 is described as a bush herein, but the type of the friction reducing member 19 is not necessarily limited thereto. For example, the friction reducing member/support 19 may be a bearing.

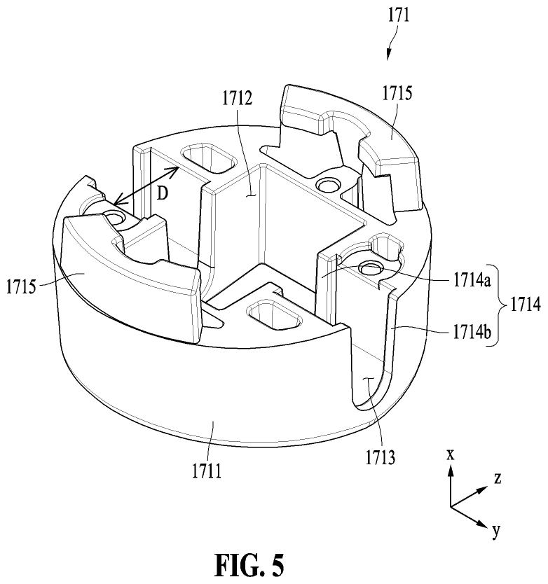

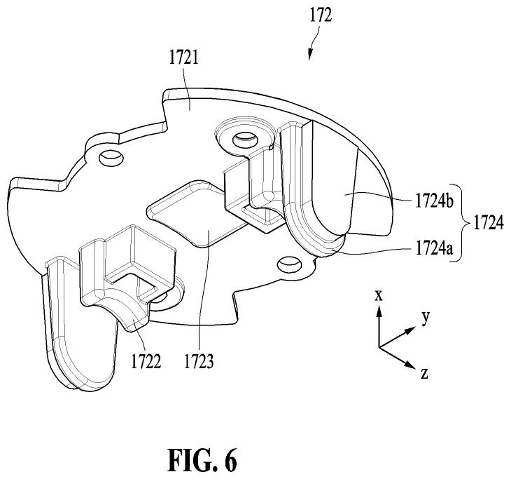

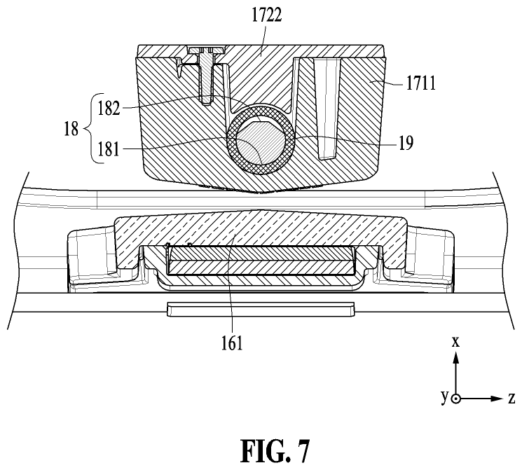

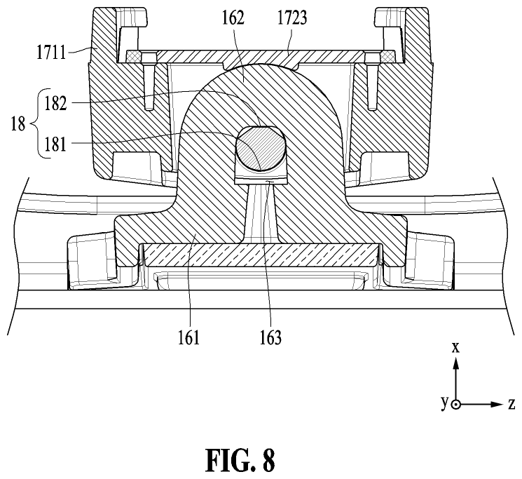

FIG. 5 is a perspective view illustrating the lower mount according to an embodiment. FIG. 6 is a perspective view illustrating the upper mount according to an embodiment. FIG. 7 is a side view illustrating the friction reducing member supported by an upper holder and a lower groove according to an embodiment. FIG. 8 is a side view illustrating the shaft supported by a slider head according to an embodiment.

Referring to FIGS. 5 to 8, according to an embodiment, the mount 17 may accommodate the slider head 162, the shaft 18, and the friction reducing member 19 therein. The lower mount 171 may include a lower body 1711, a main hole 1712, a lower groove 1713, a mount rib 1714, and a lower wing 1715.

In an embodiment, the lower body 1711 may accommodate the shaft 18. The main hole 1712 may be formed through the lower body 1711 and may accommodate the slider head 162. For example, the main hole 1712 may be formed at the center of the lower body 1711.

In an embodiment, the lower groove 1713 may accommodate the friction reducing member 19. For example, two lower grooves 1713 may be provided on both sides of the main hole 1712. The lower groove 1713 may be recessed into the lower body 1711. For example, the lower groove 1713 may have a U shape. The width D of the lower groove 1713 may be greater than or equal to the outer diameter of the friction reducing member 19.

In an embodiment, the lower groove 1713 may communicate with the main hole 1712. For example, the lower groove 1713 may also communicate with the outside of the lower body 1711. The shaft 18 may pass through the width D of the lower groove 1713 and be supported by, directly or indirectly, the friction reducing member 19 and the slider head 162.

In an embodiment, the mount rib 1714 may be formed along the edge of the lower groove 1713. The mount rib 1714 may be formed at a part where the lower groove 1713 and the main hole 1712 communicate (hereinafter, referred to as a “first rib 1714a”). For example, the mount rib 1714 may also be formed at a part where the lower groove 1713 and the outside of the lower body 1711 communicate (hereinafter, referred to as a “second rib 1714b”). The first rib 1714a and the second rib 1714b may be formed in one lower groove 1713. The mount rib 1714 may support the friction reducing member 19. The separation of the friction reducing member 19 from the lower groove 1713 may decrease.

In an embodiment, the lower wing 1715 may protrude from the lower body 1711 toward a driving frame. The lower wing 1715 may be detachably connected, directly or indirectly, to the driving frame. For example, the lower wing 1715 may be rotated and connected to the driving frame after being accommodated in the driving frame. For example, the lower wing 1715 may be screwed to the driving frame. The maintenance of a motion assist apparatus may be easy.

In an embodiment, the upper mount 172 may include an upper plate 1721, an upper holder 1722, a support 1723, and an upper wing 1724. The upper plate 1721 and the driving frame may face each other. The upper plate 1721 may be detachably coupled to the lower body 1711. For example, the upper plate 1721 may be screwed to the lower body 1711. When the shaft 18 or the friction reducing member 19 is damaged or worn out, the upper plate 1721 may be separated from the lower body 1711 to replace the damaged or worn component. The cost of maintenance of the motion assist apparatus may decrease.

In an embodiment, the upper holder 1722 may protrude from the upper plate 1721 toward a slider. For example, the upper holders 1722 may be provided as a pair. The friction reducing member 19 may be supported by, directly or indirectly, the upper holder 1722 and the lower body 1711 provided in opposite directions based on the shaft 18. The friction reducing member 19 may be fixed inside a mount. The friction reducing member 19 may not rotate with respect to the mount.

In an embodiment, a surface of the upper holder 1722 contacting the friction reducing member 19 may have a curved shape. For example, the upper holder 1722 may cover a part of the friction reducing member 19. The shaking of the friction reducing member 19 may decrease. The stable rotation of the shaft 18 with respect to the friction reducing member 19 may be possible.

In an embodiment, the support 1723 may protrude from the upper plate 1721 toward the slider body 161. The support 1723 may be provided in contact with the slider head 162. The slider head 162 may not directly contact the upper plate 1721. The slider head 162 may be stably supported by, directly or indirectly, the support 1723. A surface of the support 1723 contacting the slider head 162 may have a curved shape. For example, the curvature of the support 1723 may be the same as that of the slider head 162. The damage or wear of the slider head 162 may decrease. Stable rotation of the slider with respect to the mount may be possible.

In an embodiment, the upper wing 1724 may be accommodated in the lower groove 1713. The upper wing 1724 may protrude from the upper plate 1721 toward the slider. For example, the upper wings 1724 may be provided as a pair facing each other in the longitudinal direction of the shaft 18. The upper wing 1724 may be spaced apart from the upper holder 1722. The upper wing 1724 may overlap with the upper holder 1722 based on the longitudinal direction of the shaft 18. The friction reducing member 19 may be provided between the slider head 162 and the upper wing 1724. The shaft 18 may not separate to the outside of the mount. When the upper mount 172 is coupled, directly or indirectly, to the lower mount 171, the upper mount 172 may not move with respect to the lower mount 171. The upper mount 172 may be stably coupled to the lower mount 171. The upper wing 1724 may include a wing body 1724a and a wing head 1724b.

In an embodiment, the wing body 1724a may be inserted into the lower groove 1713. The mount rib 1714 may overlap with the wing body 1724a based on the longitudinal direction of the shaft 18. The friction reducing member 19 and the wing body 1724a may be accommodated between the first rib 1714a and the second rib 1714b. The friction reducing member 19 may be provided between the first rib 1714a and the wing body 1724a. The wing body 1724a may be provided between the friction reducing member 19 and the second rib 1714b. The range in which the friction reducing member 19 may move in the longitudinal direction of the shaft 18 may decrease. The noise and squeaks generated from the movement of the friction reducing member 19 may decrease.

In an embodiment, the wing head 1724b may protrude from the wing body 1724a in the outward direction and may be supported by, directly or indirectly, the second rib 1714b. For example, When the wing head 1724b is supported by the second rib 1714b, the outer edge of the lower body 1711 may have a smooth shape without protruding outwardly. The number of foreign materials penetrating into the mount may decrease. The damage or wear of the wing head 1724b due to the friction may decrease.

In an embodiment, the shaft 18 may include a curved surface 181 and a cutting surface 182. The curved surface 181 may contact an inner surface of the friction reducing member 19. The shaft 18 may rotate with respect to the friction reducing member 19. When the shaft 18 is accommodated in the head hole 163, at least one cutting surface 182 may contact the slider head 162. The shaft 18 may not rotate with respect to the slider head 162. In the drawings, three cutting surfaces 182 are illustrated herein, but the number is not necessarily limited thereto.

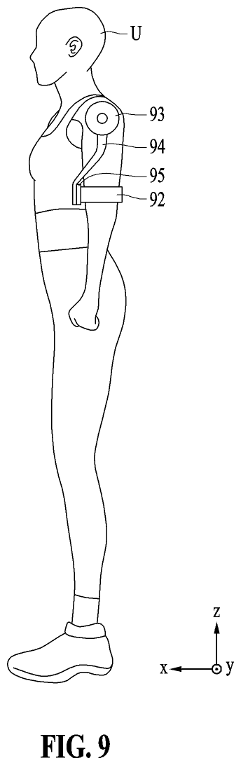

FIG. 9 is a perspective view schematically illustrating a user wearing a motion assist apparatus on the upper arm of the user, according to an embodiment.

Referring to FIG. 9, a motion assist apparatus may be worn on the upper arm of a user U. For example, an actuator 93 of the motion assist apparatus may be provided near the shoulder of the user U and a driving frame 94 may be connected to the actuator 93 and disposed along the upper arm of the user U. A slider housing 95 may be provided on the forearm of the user U. A distal support 92 may surround and support the forearm of the user U all around.

In an embodiment, a shaft may rotate with respect to a friction reducing member in a state supported by, directly or indirectly, a slider head.

In an embodiment, a mount may include an upper mount and a lower mount provided on opposite sides based on the shaft and may be coupled, directly or indirectly, to each other.

In an embodiment, the upper mount may include an upper plate and an upper holder protruding from the upper plate and configured to support the friction reducing member.

In an embodiment, the upper mount may further include a support protruding from the upper plate toward a slider body and provided in contact with the slider head.

In an embodiment, the slider head may have a convex shape in a direction away from the slider body.

In an embodiment, the lower mount may include a lower body configured to accommodate the shaft, a main hole formed through the lower body and configured to accommodate the slider head, and a lower groove configured to accommodate the friction reducing member and communicating with the main hole.

In an embodiment, the width of the lower groove may be greater than or equal to the outer diameter of the friction reducing member.

In an embodiment, the upper mount may further include an upper wing protruding from the upper plate toward a slider.

In an embodiment, the upper wing may be spaced apart from the upper holder.

In an embodiment, the friction reducing member may be provided between the slider head and the upper wing.

In an embodiment, the lower mount may further include a mount rib formed along the edge of the lower groove.

In an embodiment, the mount rib may cover at least a part of the upper wing.

In an embodiment, the mount rib may overlap with the upper wing based on the longitudinal direction of the shaft.

In an embodiment, the upper wing may include a wing body inserted into the lower groove and a wing head protruding from the wing body in the outward direction and supported by, directly or indirectly, the mount rib.

In an embodiment, the shaft may include a cutting surface contacting the slider head.

In an embodiment, the friction reducing member may be a bush.

In an embodiment, the friction reducing member may be a bearing.

The features of embodiments described above may be combined unless technically clearly impossible.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

1. A motion assist apparatus comprising:
a proximal support configured to support a proximal part of a user;
a distal support configured to support a distal part of the user;
an actuator connected to the proximal support and configured to generate power;
a driving frame configured to transmit power from the actuator to the distal support;
a slider housing connected to the distal support and including a sliding space;
a slider comprising a slider body slidably provided in the sliding space, a slider head protruding from the slider body, and a head hole formed through the slider head;
a mount connected to the driving frame and configured to accommodate the slider head;
a shaft passing through the head hole and fixed to the slider head; and
a friction reducing member, comprising a support, configured to support the shaft and accommodated in the mount.

2. The motion assist apparatus of claim 1, wherein the shaft is rotatable with respect to the friction reducing member in a state supported by the slider head.

3. The motion assist apparatus of claim 1, wherein the mount comprises an upper mount and a lower mount coupled to each other.

4. The motion assist apparatus of claim 3, wherein the upper mount comprises an upper plate and an upper holder protruding from the upper plate and configured to support the friction reducing member.

5. The motion assist apparatus of claim 4, wherein the upper mount further comprises a support protruding from the upper plate toward the slider body and provided in contact with the slider head.

6. The motion assist apparatus of claim 5, wherein the slider head has a convex shape in a direction away from the slider body.

7. The motion assist apparatus of claim 4, wherein the lower mount comprises a lower body configured to accommodate the shaft, a main hole formed through the lower body and configured to accommodate the slider head, and a lower groove configured to accommodate the friction reducing member and for communicating with the main hole.

8. The motion assist apparatus of claim 7, wherein the lower groove has a width greater than or equal to an outer diameter of the friction reducing member.

9. The motion assist apparatus of claim 7, wherein the upper mount comprises an upper wing protruding from the upper plate toward the slider.

10. The motion assist apparatus of claim 9, wherein the upper wing is spaced apart from the upper holder.

11. The motion assist apparatus of claim 9, wherein the friction reducing member is provided between the slider head and the upper wing.

12. The motion assist apparatus of claim 11, wherein the lower mount further comprises a mount rib formed along an edge of the lower groove.

13. The motion assist apparatus of claim 12, wherein the mount rib is configured to cover at least a part of the upper wing.

14. The motion assist apparatus of claim 12, wherein the mount rib overlaps with the upper wing based on a longitudinal direction of the shaft.

15. The motion assist apparatus of claim 12, wherein the upper wing comprises a wing body inserted into the lower groove and a wing head protruding from the wing body in an outward direction and supported by the mount rib.

16. The motion assist apparatus of claim 1, wherein the shaft comprises a cutting surface contacting the slider head.

17. The motion assist apparatus of claim 1, wherein the friction reducing member comprises a bush.

18. The motion assist apparatus of claim 1, wherein the friction reducing member comprises a bearing.
